(19) United States
(12) Patent Application Publication
(10) Pub. No.: US 2015/0234522 A1
(43) Pub. Date: Aug. 20, 2015

(54) TOUCH EVENT SCAN METHOD, ELECTRONIC DEVICE AND STORAGE MEDIUM

(71) Applicants: Hisense Electric Co., Ltd., Qingdao (CN); HISENSE USA CORP., Suwanee, GA (US)

(72) Inventors: Xu ZHANG, Qingdao (CN); Shoushuai WANG, Qingdao (CN)

(73) Assignees: Hisense Electric Co., Ltd, Qingdao (CN); HISENSE USA CORP., Suwanee, GA (US)

(21) Appl. No.: 14/292,407

(22) Filed: May 30, 2014

(30) Foreign Application Priority Data
Feb. 19, 2014 (CN) 201410056417.X

(51) Int. Cl. G06F 3/041; G06F 3/042

(52) U.S. Cl. CPC G06F 3/0416; G06F 3/0412; G06F 3/0421

(57) ABSTRACT

The invention discloses a touch event scan method including: starting a scan over an entire touch screen, determining a location of a touch point, corresponding to a touch event, on the touch screen when the touch event is detected; determining an area of a preset size including at least the touch point corresponding to the detected touch event as a scan area according to the determined location, wherein the scan area is smaller than the entire touch screen; and scanning at least the scan area for the touch event.

### CROSS-REFERENCES TO RELATED APPLICATIONS

The present application claims priority to Chinese Patent Application No. 201410056417.X, filed with the State Intellectual Property Office of People's Republic of China on Feb. 19, 2014 and entitled “Touch event scan method, electronic device and storage medium”, which is incorporated herein by reference in its entirety for all purposes.

### FIELD OF THE INVENTION

Embodiments of the present invention relate to a touch screen scan method, an electronic device and a storage medium.

### BACKGROUND OF THE INVENTION

At present, a touch screen is commonly configured for numerous electronic devices to facilitate operations of a user on the electronic devices while dispensing with other peripheral devices, e.g., a keyboard, a mouse, etc. However the user operating on the touch screen may suffer from a response delay of the touch screen in the course of accessing the touch screen in practice.

### SUMMARY OF THE INVENTION

An embodiment of the invention provides a touch event scan method including: starting a scan over an entire touch screen, determining a location of a touch point, corresponding to a touch event, on the touch screen when the touch event is currently detected; determining an area of a preset size including at least the touch point corresponding to the touch event currently detected as a scan area according to the determined location, wherein the scan area is smaller than the entire touch screen; and scanning at least the scan area for a touch event.

An embodiment of the invention further provides an electronic device including a touch screen, one or more processors and a memory.

The memory has one or more computer readable program codes stored therein, and the one or more processors are configured to execute the one or more computer readable program codes to perform: starting a scan over the entire touch screen, determining a location of a touch point, corresponding to a touch event, on the touch screen when the touch event is currently detected; determining an area of a preset size including at least the touch point corresponding to the touch event currently detected as a scan area according to the determined location, wherein the scan area is smaller than the entire touch screen; and scanning at least the scan area for a touch event.

An embodiment of the invention further provides a computer readable storage medium including one or more programs stored therein which cause, upon being executed by an electronic device with a touch screen, the electronic device to perform a method including: starting a scan over the entire touch screen, determining a location of a touch point, corresponding to a touch event, on the touch screen when the touch event is currently detected; determining an area of a preset size including at least the touch point corresponding to the touch event currently detected as a scan area according to the determined location, wherein the scan area is smaller than the entire touch screen; and scanning at least the scan area for a touch event.

### BRIEF DESCRIPTION OF THE DRAWINGS

FIG. 1 is a schematic diagram of a scan direction of infrared diodes in an infrared touch screen according to an embodiment of the invention;

FIG. 2 is a flow chart of a touch event scan method according to an embodiment of the invention;

FIG. 3 is a flow chart of a method of determining a scan area according to an embodiment of the invention;

FIG. 4 is a flow chart of a method of determining a motion direction of a touch locus of a touch event according to an embodiment of the invention;

FIG. 5 is a schematic diagram of a determined tangential direction of a touch point according to an embodiment of the invention;

FIG. 6 is a schematic diagram of an electronic device according to an embodiment of the invention.

### DETAILED DESCRIPTION OF THE PREFERRED EMBODIMENT

A touch event scan method according to an embodiment of the invention is as illustrated in FIG. 2.

In the block 101 of FIG. 2, a scan over an entire touch screen is started, and a location of a touch point, corresponding to a touch event, on the touch screen is determined when the touch event is detected.

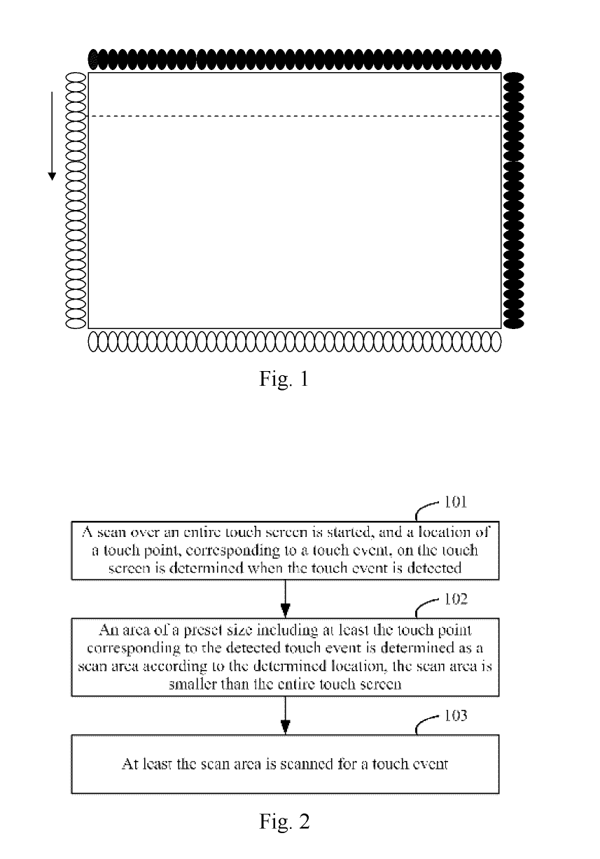

Taking an infrared touch screen as an example, this touch screen is touch-controlled typically by infrared touch control based upon an infrared touch frame, that is, infrared transmitting diodes and infrared receiving diodes are installed at edges of the rectangular touch screen as illustrated in FIG. 1, infrared diodes at the left edge and the bottom edge are infrared transmitting diodes, and infrared diodes at the top edge and the right edge are infrared receiving diodes, and there is a one-to-one correspondence relationship between the transmitting diode and the receiving diode opposite in the horizontal direction or the vertical direction (two infrared diodes connected by the dotted line in FIG. 1 are a pair of diodes). Starting with an infrared transmitting diode, the transmitting diodes are started sequentially to emit infrared in a preset order, e.g., counterclockwise, and the infrared receiving diodes corresponding thereto receive the emitted infrared, and this process is referred to as a sequential scan, a process in which the sequential scan is performed cyclically to scan for a touch event is referred to as a sequential cyclic scan.

In the process of the sequential cyclic scan, when there is an object touching the screen, and if infrared transmitting diodes in the horizontal and vertical directions intersecting at the location at which the touch screen is touched by the object are emitting infrared, then the infrared emitted by the infrared transmitting diodes in the horizontal and vertical directions intersecting at the corresponding location will be blocked by the object, and the corresponding infrared receiving diodes will not receive the infrared, that is, an event of touching the touch screen by the object can be detected (or located), and finally the location of the touch event on the touch screen will be determined by the infrared receiving diodes in the horizontal and vertical directions. If the location at which the touch screen is touched by the object is kept unchanged, then an interval of time between two instances of locating touch events of touching the touch screen by the object is a scan cycle.

The invention will not be limited to this infrared touch screen but can also be applicable to a touch screen for which another scan scheme is adopted.

When there is a touch event, one or more pairs of infrared diodes may be blocked by the touch event respectively in the horizontal and vertical directions, and if the point at which a pair of infrared diodes blocked in the horizontal direction intersect a pair of infrared diodes blocked in the vertical direction is referred to as a touch point, then the touch event may correspond to one or more touch points. Initially the scan over the entire touch screen is started, that is, the entire infrared touch screen is scanned for a touch event in the sequential cyclic scan, and the location of a touch point, corresponding to a touch event, on the infrared touch screen is determined when the touch event is detected (the touch event is located for the first time), and particularly how to determine the location is known in the art, so a repeated description thereof will be omitted here. In an embodiment, if touch events refer to sliding on the screen, then the numbers of touch points corresponding to the touch events at different locations on the infrared touch screen may be the same or may be different, that is, when there are touch events of sliding on the infrared touch screen, the numbers of touch points corresponding to the touch events detected at different instances of time may be the same or may be different.

In an embodiment, a detected touch event is determined when a finger or another touching object touching the touch screen or sliding on the touch screen is detected.

When there is one touch point corresponding to a touch event detected each time, the location of the touch point on the touch screen is determined as the location of the touch point, corresponding to the detected touch event, on the touch screen; and when there are multiple touch points corresponding to the detected touch event, the location of the touch point, corresponding to the touch event, on the touch screen can be determined according to a preset rule which can be but will not be limited to that the location of a centrally positioned touch point, among the multiple touch points corresponding to the touch event, on the touch screen is determined as the location of the touch point, corresponding to the detected touch event, on the touch screen, or the location of the touch point, corresponding to the detected touch event, on the touch screen can be determined according to another preset rule.

Taking an infrared touch screen as an example, in an embodiment, the location of each touch point on the touch screen can be determined by setting an absolute coordinate origin on the infrared touch screen and determining the location of the touch point relative to the absolute coordinate origin as the location of the touch point on the infrared touch screen or by determining the location of the touch point relative to a preceding touch point as the location of the touch point on the infrared touch screen, that is, offset coordinates of the touch point relative to the preceding touch point.

In the block 102 of FIG. 2, an area of a preset size including at least the touch point corresponding to the detected touch event is determined as a scan area according to the determined location, the scan area is smaller than the entire touch screen.

In an embodiment, after the location of the touch point, corresponding to the detected touch event, on the touch screen is determined, a scan area including at least the touch point corresponding to the detected touch event is determined according to the location of the touch point, corresponding to the touch event at that instance of time, on the touch screen, the size of the scan area is smaller than the size of the entire touch screen. Particularly the size of the scan area can be derived experimentally by simulation according to the size of the real touch screen and other factors, and the size of the scan area will not be limited here.

In the block 103 of FIG. 2, at least the scan area is scanned for a touch event.

Generally when there are touch events of sliding on the touch screen (e.g., a finger sliding on the touch screen), there is a short distance between the location of a touch point, corresponding to a touch event detected at a preceding instance of time, on the touch screen and the location of a touch point, corresponding to a touch event detected at a current instance of time, on the touch screen, or there is a definite motion locus of the touch events, so the touch events can be scanned for rapidly in the embodiment of the invention.

When the screen is scanned for a touch event in the sequential cyclic scan, the sequential cyclic scan will apply regardless of whether the touch event is located on the touch screen, and the same scan area on the touch screen will not be scanned again until there is one scan cycle after the scan area is scanned.

In the embodiment of the invention, the location of a touch point, corresponding to a touch event, on the touch screen is predetermined, and an area in which the touch event is likely to occur at a succeeding instance of time is scanned in advance, that is, a scan area including at least the touch point corresponding to the currently detected touch event and sized smaller than the touch screen is determined according to the location of the touch point, corresponding to the currently detected touch event, on the touch screen, and at least the scan area is scanned for a touch event, so that a touch event can be detected in a timely manner when the touch event moves into the predetermined scan area to thereby shorten a scan cycle of the touch event and effectively lowering a touch delay. Moreover the corresponding touch point will vary in real time with the sliding touch events, and with the method and the electronic device according to the embodiments of the invention, the scan area will also be updated in real time as the touch point varies in real time to thereby address the problems in the prior art of a slow touch response, an interrupted touch and a touch error arising from a touch delay; and further, power consumption can be lowered due to a narrowed scan range.

In an embodiment, taking an infrared touch screen as an example, initially the entire screen is scanned for a touch event in a sequential cyclic scan, and after a touch event is detected and a scan area is determined in the process of the sequential cyclic scan, at least the scan area can be scanned for a touch event according to the embodiment of the invention in the following scan schemes.

In a first scheme, the scan over the entire touch screen is stopped, and only the determined scan area is scanned for a touch event; and if it is determined that a touch event has not been located in the scan area for a preset length of time, then the scan over the entire touch screen is restarted, and the entire touch screen is scanned for a touch event. The determined scan area can be scanned for a touch event in an existing scan mode other than a sequential cyclic scan or still in a sequential cyclic scan, and the existing scan mode other than a sequential cyclic scan is well known to those skilled in the art, so a repeated description thereof will be omitted here.

The size of the preset length of time can depend upon a real condition, but the size of the preset length of time at least can accommodate a full scan over the entire scan area in that length of time. The size of the length of time can be derived experimentally by simulation and will not be limited here.

In this scheme, the absence of a touch event located in the scan area for the present length of time indicates that touch events occur in an area beyond the scan area or that touch events have been ended at that time, so when a touch event has not been located in the scan area, the entire touch screen is scanned for a touch event, and when a touch event is located in the area beyond the scan area, a touch event is further scanned for in the touch event scan method according to the embodiment of the invention, thus preventing a touch event from being skipped in scanning.

In this scheme, a scan cycle of a touch event can be shortened to thereby match a sliding speed with a scan speed and lower the ratio of false negatives and the ratio of false positives, thus avoiding to some extent the problem of a touch delay from occurring.

In a second scheme, another area of the touch screen than the determined scan area is scanned for a touch event in a scan mode corresponding to the scan over the entire touch screen in addition to scanning the scan area for a touch event. The determined scan area can be scanned for a touch event in an existing scan mode other than a scan mode corresponding to the scan over the entire touch screen, and if the scan mode corresponding to the scan over the entire touch screen is a sequential cyclic scan, then the determined scan area can be scanned for a touch event in a scan mode where one infrared transmitting diode corresponds to multiple infrared receiving diodes, or the scan area can be scanned for a touch event in an alternative mode.

In this scheme, the scan area and the other area than the scan area are scanned concurrently for a touch event to thereby improve a scan rate for a touch event.

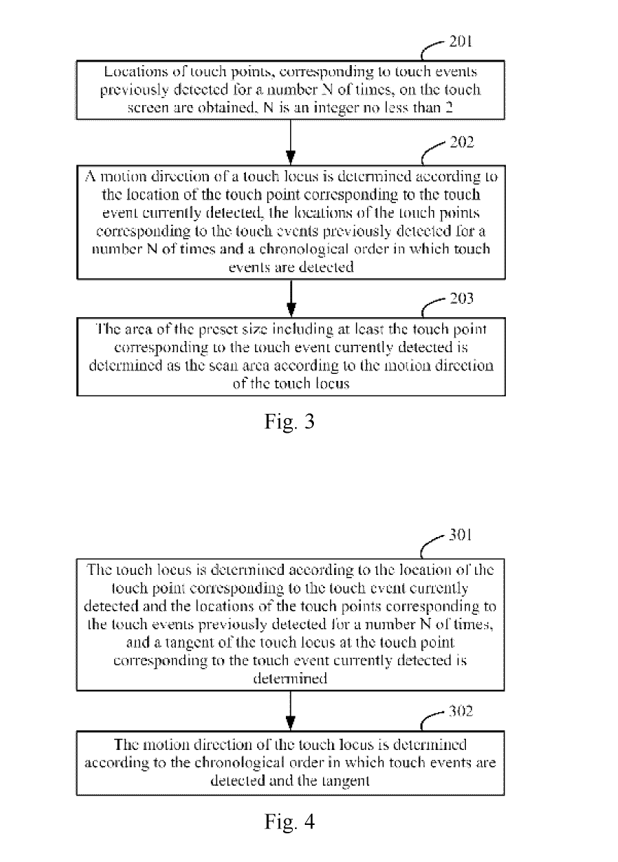

In an embodiment, an area of a preset size including at least the touch point corresponding to the detected touch event is determined as a scan area according to the determined location as illustrated in FIG. 3.

In the block 201 of FIG. 3, locations of touch points, corresponding to touch events previously detected for a number N of times, on the touch screen are obtained, N is an integer no less than 2.

In the block 202 of FIG. 3, a motion direction of a touch locus is determined according to the location of the touch point corresponding to the touch event currently detected, the locations of the touch points corresponding to the touch events previously detected for a number N of times and a chronological order in which the touch events are detected.

Since the touch points corresponding to the touch events detected each time (typically touch points corresponding to the touch events detected at different instances of time) are different from each other, the motion direction of the touch locus of the touch events can be determined according to the touch points corresponding to the touch events previously detected for a number N of times and the touch point corresponding to the currently detected touch event, that is, the motion direction of the touch events can be determined according to the chronological order in which the touch events are detected.

In the block 203 of FIG. 3, the area of the preset size including at least the touch point corresponding to the currently detected touch event is determined as the scan area according to the motion direction of the touch locus.

In an embodiment, the location of the scan area on the touch screen is updated in real time in the same direction as the motion direction of the touch locus according to the location of the touch point, corresponding to a touch event detected each time, on the touch screen. If a touch event has not been located in the scan area updated in real time, then the entire touch screen is scanned again for a touch event.

In an embodiment, the scan area is determined so that the scan area is sure to include the touch point corresponding to the currently detected touch event; and since the touch events are sliding constantly, the location of the scan area to be determined will also be updated in real time with the touch point corresponding to a touch event detected each time. Thus the scan area can be determined in real time according to the touch point corresponding to a touch event detected at the current instance of time to thereby shorten a scan cycle for a touch event and effectively lower a touch delay.

In an embodiment, the motion direction of the touch locus is determined according to the location of the touch point corresponding to the currently detected touch event, the locations of the touch points corresponding to the touch events previously detected for a number N of times and the chronological order in which the touch events are detected, as illustrated in FIG. 4.

In the block 301 of FIG. 4, the touch locus is determined according to the location of the touch point corresponding to the currently detected touch event and the locations of the touch points corresponding to the touch events previously detected for a number N of times, and a tangent of the touch locus at the touch point corresponding to the currently detected touch event, is determined.

In an embodiment, the touch locus is determined according to the location of the touch point, corresponding to the currently detected touch event, on the touch screen and the locations of the touch points corresponding to the touch events previously detected for a number N of times, and the tangent of the touch locus at the touch point corresponding to the touch event detected at the current instance of time is determined, or tangents of the touch locus at touch points corresponding to two instances of time closest to the current instance of time and the tangent of the touch locus at the touch point corresponding to the touch event detected at the current instance of time are determined.

Typically the sliding locus of the touch events or the occurrence locus of the touch events complies with some regularity, and there is a higher probability that the sliding direction of the touch events is the tangent direction of the determined touch locus at the touch point corresponding to the touch event detected at the current instance of time.

In the block 302 of FIG. 4, the motion direction of the touch locus is determined according to the chronological order in which the touch events are detected and the tangent.

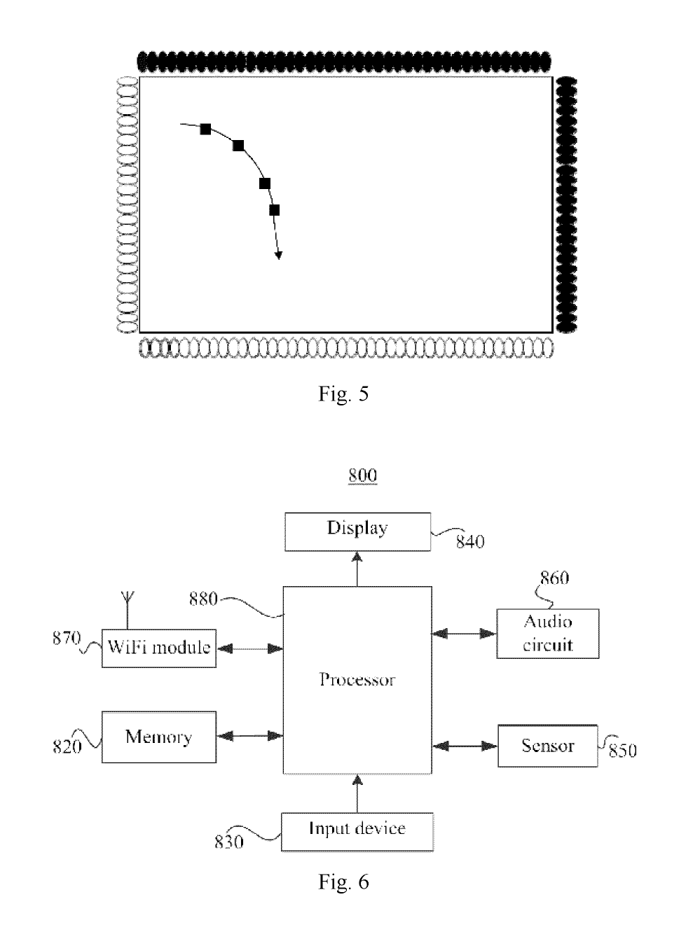

In an embodiment, the direction from a touch point corresponding to a touch event detected prior to the current instance of time to the touch point corresponding to the currently detected touch event is determined as the tangent direction at the touch point corresponding to the currently detected touch event according to the chronological order in which the touch events are detected, and the tangent direction is determined as the motion direction of the touch locus, as illustrated in FIG. 5, the direction denoted by the arrow is the tangent direction at the touch point corresponding to the currently detected touch event.

In an embodiment, when there are multiple touch points corresponding to the detected touch event, a centrally positioned touch point, among the touch points corresponding to the detected touch event, on the touch screen can be determined as the touch point, corresponding to the touch event detected at that instance of time, on the touch screen; or the average of the locations of the touch points, corresponding to the detected touch event, on the touch screen can be determined as the touch point, corresponding to the touch event detected at that instance of time, on the touch screen; or a touch point closest to an edge, among the touch points corresponding to the detected touch event, on the touch screen can be determined as the touch point, corresponding to the touch event detected at that instance of time, on the touch screen.

Typically the sliding locus of the touch events or the occurrence locus of the touch events complies with some regularity, and there is a higher probability that the motion direction of the touch locus is the tangent direction determined in the embodiment of the invention, so the touch events can be located more rapidly in the embodiment of the invention.

In an embodiment of the invention, the determined direction of the tangent can be determined as the occurrence direction of the scan area to thereby prevent the touch events moving at a high speed on the touch screen from going beyond the determined scan area, thus ensuring rapid determination of the scan area and immediate revision of the scan area in the scan method according to the embodiment of the invention when a touch event has not occurred in the tangent direction.

In an embodiment, the determined scan area is a regular graph centered at the current touch point, and in an embodiment, the regular graph is a rectangular in which a pair of opposite sides are two opposite edge frames in the touch screen.

Thus touch events can be located rapidly in the case of an indefinite motion locus (direction) of the touch events. Also the touch events can be located rapidly when the touch events move departing from the motion direction of the touch locus.

The touch event scan method and device according to the embodiments of the invention can be applicable to an infrared touch screen and also to a touch screen of another type.

Based upon the same inventive idea as the touch event scan method according to an embodiment of the invention, an embodiment of the invention further provides an electronic device 800 which can be a television set (as illustrated in FIG. 6), a medical electronic device, etc., and the invention will be limited thereto.

The electronic device 800 can include a memory 820 including one or more computer readable storage mediums, an input device 830, a display 840, a sensor 850, an audio circuit 860, a WiFi (Wireless Fidelity) module 870, a processor 880 including one or more processing cores, and other components. Those skilled in the art can appreciate that the electronic device will not be limited to the structure of the television set illustrated in FIG. 6 but can include more or less components than those as illustrated or some of the components can be combined or different components can be arranged.

The memory 820 can be configured to store software programs and modules, and the processor 880 is configured to run the software programs and modules stored in the memory 820 to thereby perform various function applications and data processes. The memory 820 can generally include a program storage area and a data storage area, an operating system, applications required for at least one function (e.g., an audio playing function, an image playing function, etc.), etc., can be stored in the program storage area; and data created for use by the electronic device (e.g., audio data, an address book, etc.), etc., can be stored in the data storage area. Moreover the memory 820 can include a high-speed random access memory and can further include a nonvolatile memory, e.g., at least one magnetic disk memory device, a flash memory device or another volatile solid memory device. Correspondingly the memory 820 can further include a memory controller configured to provide an access of the processor 880 and the input device 830 to the memory 820.

The input device 830 can be configured to receive an input control instruction, e.g., an instruction issued by a user to the electronic device 800 through a press key or another element.

The display 840 can be configured to display various graphic user interfaces of the electronic devices 800. The graphic user interfaces can be composed of graphics, texts, icons, videos or any combination thereof. The display 840 can include a display panel, and optionally a display panel can be configured in the form of a Liquid Crystal Display (LCD), an Organic Light-Emitting Diode (OLED) display, etc.

The electronic device 800 can further include at least one sensor 850, e.g., an optical sensor and other sensors, e.g., various medical sensors.

The audio circuit 860 can output audio of the electronic device 800 by converting an audio signal into an electric signal and outputting it through a speaker (not illustrated). WiFi is a technology of short-range wireless transmission, and the electronic device 800 can facilitate an access of the user to a local area network or a wide area network through the WiFi module 870 to thereby achieve interconnection and intercommunication with another device, to transmit and receive an email, to browse a webpage, to access streaming media, to assist in remote medical treatments, etc. Although FIG. 6 illustrates the WiFi module, it can be appreciated that it is not necessarily required for the electronic device 800 but can be omitted as desired without departing from the scope of the invention.

The processor 880 is a control center of the electronic device 800, has the respective components of the entire electronic device connected by various interfaces and lines, and runs or executes the software programs and/or modules stored in the memory 820 and invokes the data stored in the memory 820 to perform the various functions of the electronic device 800 and process the data to thereby manage and control the electronic device as a whole. Optionally the processor 880 can include one or more processing cores.

In an embodiment of the invention, the memory 820 has one or more programs stored therein which are configured to be executed by one or more processors. The one or more programs include instructions for performing the method as illustrated in FIG. 2, FIG. 3 and FIG. 4, and for details of the method, reference can be made to FIG. 2, FIG. 3 and FIG. 4 and the relevant descriptions thereof.

An embodiment of the invention further provides a computer readable storage medium which can be a computer readable storage medium included in the memory according to the embodiment described above or which can be embodied separately as a computer readable storage medium which is not installed in the electronic device. The computer readable storage medium includes one or more programs stored therein. The one or more programs are executed by one or more processors to perform the method as illustrated in FIG. 2, FIG. 3 and FIG. 4, and for details of the method, reference can be made to FIG. 2, FIG. 3 and FIG. 4 and the relevant descriptions thereof.

One or more embodiments of the invention can have the following one or more advantageous effects over the prior art although these embodiments may not have these advantageous effects. Accordingly these advantageous effects described here shall not be construed to limit the scope of the invention.

With the touch event scan solution according to the embodiments of the invention, after a scan over the entire touch screen is started and a touch event is detected, a scan area is determined according to a touch point corresponding to the detected touch event; and since the determined scan area is smaller than the entire touch screen, the scan area is scanned for a touch event to thereby shorten a scan cycle for the touch event, and the shorter the scan cycle is, the shorter a detection cycle for a touch event is, and thus effectively lower a touch delay. Moreover the corresponding touch point varies in real time with the sliding touch event, and with the solution according to the embodiments of the invention, the scan area is also updated in real time as the touch point varies in real time to thereby address the problems in the prior art of a slow touch response, an interrupted touch and a touch error arising from a touch delay; and furthermore, power consumption can be lowered due to a narrowed scan range.

From the disclosure provided herein, various modifications and variations to the invention can be made without departing from the essence and scope of the disclosure. Thus the disclosure is also intended to encompass these modifications and variations thereto.

What is claimed is:

1. A touch event scan method comprising:
starting a scan over an entire touch screen, and determining a location of a touch point, corresponding to a touch event, on the touch screen when the touch event is currently detected;
determining an area of a preset size including at least the touch point corresponding to the touch event currently detected as a scan area according to the determined location, wherein the scan area is smaller than the entire touch screen; and
scanning at least the scan area for a touch event.

2. The method of claim 1, wherein the scanning at least the scan area for a touch event comprises:
stopping the scan over the entire touch screen, and scanning only the scan area for a touch event; and
when it is determined that a touch event has not been detected in the scan area for a preset length of time, restarting the scan over the entire touch screen.

3. The method of claim 1, wherein the scanning at least the scan area for a touch event comprises:
scanning other area of the touch screen than the scan area for a touch event in a scan mode corresponding to the scan over the entire touch screen in addition to scanning the scan area for a touch event.

4. The method of claim 1, wherein the determining the area of the preset size including at least the touch point corresponding to the touch event currently detected as the scan area according to the determined location comprises:
obtaining locations of touch points, corresponding to touch events previously detected for a number N of times, on the touch screen, wherein N is an integer no less than 2;
determining a motion direction of a touch locus according to the location of the touch point corresponding to the touch event currently detected, the locations of the touch points corresponding to the touch events previously detected for a number N of times and a chronological order in which touch events are detected; and
determining the area of the preset size including at least the touch point corresponding to the touch event currently detected as the scan area according to the motion direction of the touch locus.

5. The method of claim 4, wherein the determining the motion direction of the touch locus according to the location of the touch point corresponding to the touch event currently detected, the locations of the touch points corresponding to the touch events previously detected for a number N of times and the chronological order in which touch events are detected comprises:
determining the touch locus according to the location of the touch point corresponding to the touch event currently detected and the locations of the touch points corresponding to the touch event previously detected for a number N of times, and determining a tangent of the touch locus at the touch point corresponding to the touch event currently detected; and
determining the motion direction of the touch locus according to the chronological order in which touch events are detected and the tangent.

6. The method of claim 2, wherein the determining the area of the preset size including at least the touch point corresponding to the touch event currently detected as the scan area according to the determined location comprises:
obtaining locations of touch points, corresponding to touch events previously detected for a number N of times, on the touch screen, wherein N is an integer no less than 2;
determining a motion direction of a touch locus according to the location of the touch point corresponding to the touch event currently detected, the locations of the touch points corresponding to the touch events previously detected for a number N of times and a chronological order in which touch events are detected; and
determining the area of the preset size including at least the touch point corresponding to the touch event currently detected as the scan area according to the motion direction of the touch locus.

7. The method of claim 6, wherein the determining the motion direction of the touch locus according to the location of the touch point corresponding to the touch event currently detected, the locations of the touch points corresponding to the touch events previously detected for a number N of times and the chronological order in which touch events are detected comprises:
determining the touch locus according to the location of the touch point corresponding to the touch event currently detected and the locations of the touch points corresponding to the touch event previously detected for a number N of times, and determining a tangent of the touch locus at the touch point corresponding to the touch event currently detected; and
determining the motion direction of the touch locus according to the chronological order in which touch events are detected and the tangent.

8. The method of claim 3, wherein the determining the area of the preset size including at least the touch point corresponding to the touch event currently detected as the scan area according to the determined location comprises:
obtaining locations of touch points, corresponding to touch events previously detected for a number N of times, on the touch screen, wherein N is an integer no less than 2;
determining a motion direction of a touch locus according to the location of the touch point corresponding to the touch event currently detected, the locations of the touch points corresponding to the touch events previously detected for a number N of times and a chronological order in which touch events are detected; and
determining the area of the preset size including at least the touch point corresponding to the touch event currently detected as the scan area according to the motion direction of the touch locus.

9. The method of claim 8, wherein the determining the motion direction of the touch locus according to the location of the touch point corresponding to the touch event currently detected, the locations of the touch points corresponding to the touch events previously detected for a number N of times and the chronological order in which touch events are detected comprises:
determining the touch locus according to the location of the touch point corresponding to the touch event currently detected and the locations of the touch points corresponding to the touch events previously detected for a number N of times, and determining a tangent of the touch locus at the touch point corresponding to the touch event currently detected; and
determining the motion direction of the touch locus according to the chronological order in which touch events are detected and the tangent.

10. An electronic device, comprising:
a touch screen;
one or more processors; and
a memory;
wherein the memory stores one or more computer readable program codes, and the one or more processors are configured to execute the one or more computer readable program codes to perform:
starting a scan over the entire touch screen, and determining a location of a touch point, corresponding to a touch event, on the touch screen when the touch event is currently detected;
determining an area of a preset size including at least the touch point corresponding to the touch event currently detected as a scan area according to the determined location, wherein the scan area is smaller than the entire touch screen; and
scanning at least the scan area for a touch event.

11. The electronic device of claim 10, wherein the scanning at least the scan area for a touch event comprises:
stopping the scan over the entire touch screen, and scanning only the scan area for a touch event; and
when it is determined that a touch event has not been detected in the scan area for a preset length of time, restarting the scan over the entire touch screen.

12. The electronic device of claim 10, wherein the scanning at least the scan area for a touch event comprises:
scanning other area of the touch screen than the scan area for a touch event in a scan mode corresponding to the scan over the entire touch screen in addition to scanning the scan area for a touch event.

13. The electronic device of claim 10, wherein the determining the area of the preset size including at least the touch point corresponding to the touch event currently detected as the scan area according to the determined location comprises:
obtaining locations of touch points, corresponding to touch events previously detected for a number N of times, on the touch screen, wherein N is an integer no less than 2;
determining a motion direction of a touch locus according to the location of the touch point corresponding to the touch event currently detected, the locations of the touch points corresponding to the touch events previously detected for a number N of times and a chronological order in which touch events are detected; and
determining the area of the preset size including at least the touch point corresponding to the touch event currently detected as the scan area according to the motion direction of the touch locus.

14. The electronic device of claim 13, wherein the determining the motion direction of the touch locus according to the location of the touch point corresponding to the touch event currently detected, the locations of the touch points corresponding to the touch events previously detected for a number N of times and the chronological order in which touch events are detected comprises:
determining the touch locus according to the location of the touch point corresponding to the touch event currently detected and the locations of the touch points corresponding to the touch event previously detected for a number N of times, and determining a tangent of the touch locus at the touch point corresponding to the touch event currently detected; and
determining the motion direction of the touch locus according to the chronological order in which the touch events are detected and the tangent.

15. The electronic device of claim 10, wherein the electronic device is a television set or a medical electronic device.

16. A computer readable storage medium storing one or more programs, wherein the one or more programs cause, upon being executed by an electronic device with a touch screen, the electronic device to perform a method comprising:
starting a scan over the entire touch screen, and determining a location of a touch point, corresponding to a touch event, on the touch screen when the touch event is currently detected;
determining an area of a preset size including at least the touch point corresponding to the touch event currently detected as a scan area according to the determined location, wherein the scan area is smaller than the entire touch screen; and
scanning at least the scan area for a touch event.

17. The storage medium of claim 16, wherein the scanning at least the scan area for a touch event comprises:
stopping the scan over the entire touch screen, and scanning only the scan area for a touch event; and
when it is determined that a touch event has not been detected in the scan area for a preset length of time, restarting the scan over the entire touch screen.

18. The storage medium of claim 16, wherein the scanning at least the scan area for a touch event comprises:
scanning other area of the touch screen than the scan area for a touch event in a scan mode corresponding to the scan over the entire touch screen in addition to scanning the scan area for a touch event.

19. The storage medium of claim 16, wherein the determining the area of the preset size including at least the touch point corresponding to the touch event currently detected as the scan area according to the determined location comprises:
obtaining locations of touch points, corresponding to touch events previously detected for a number N of times, on the touch screen, wherein N is an integer no less than 2;
determining a motion direction of a touch locus according to the location of the touch point corresponding to the touch event currently detected, the locations of the touch points corresponding to the touch events previously detected for a number N of times and a chronological order in which touch events are detected; and
determining the area of the preset size including at least the touch point corresponding to the touch event currently detected as the scan area according to the motion direction of the touch locus.

20. The storage medium of claim 19, wherein the determining the motion direction of the touch locus according to the location of the touch point corresponding to the touch event currently detected, the locations of the touch points corresponding to the touch events previously detected for a number N of times and the chronological order in which touch events are detected comprises:
determining the touch locus according to the location of the touch point corresponding to the touch event currently detected and the locations of the touch points corresponding to the touch event previously detected for a number N of times, and determining a tangent of the touch locus at the touch point corresponding to the touch event currently detected; and
determining the motion direction of the touch locus according to the chronological order in which touch events are detected and the tangent.
